(19) United States
(12) Patent Application Publication
(10) Pub. No.: US 2025/0224637 A1
(43) Pub. Date: Jul. 10, 2025

(54) OPTICAL FILM, BACKLIGHT MODULE, AND DISPLAY DEVICE

(71) Applicant: Radiant Opto-Electronics Corporation, KAOHSIUNG (TW)

(72) Inventors: Chun-Yi WU, KAOHSIUNG (TW); Wei-Hsuan CHEN, KAOHSIUNG (TW); Yung-Hui TAI, KAOHSIUNG (TW); Chung-Yung TAI, KAOHSIUNG (TW); Wen-Hao CAI, KAOHSIUNG (TW); Chun-Hau LAI, KAOHSIUNG (TW); Jun-Ping LIN, KAOHSIUNG (TW)

(73) Assignee: Radiant Opto-Electronics Corporation, KAOHSIUNG (TW)

(21) Appl. No.: 19/093,579

(22) Filed: Mar. 28, 2025

Related U.S. Application Data
(63) Continuation of application No. PCT/CN2023/135231, filed on Nov. 29, 2023.

(30) Foreign Application Priority Data
Nov. 29, 2023 (WO) PCT/CN2023/135231

(51) Int. Cl. G02F 1/13357

(52) U.S. Cl. CPC G02F 1/133606

(57) ABSTRACT

An optical film comprises a substrate and a plurality of microstructures positioned on a light incident surface of the substrate. The substrate is defined to have a first direction and a second direction perpendicular to the first direction. The cross-sectional shape of the microstructures in the first direction is different from that in the second direction. Each of the microstructures has multiple optical surfaces and a boundary line connecting the multiple optical surfaces. The boundary line is a straight line and parallel to the light incident surface of the substrate. Through the structural design of the microstructures on the optical film, the light distribution of the light source is expanded to achieve the purpose of specific angle illumination. The present invention also provides a backlight module and a display device including the optical film.

### RELATED APPLICATIONS

This application is a continuation application of International Application No. PCT/CN2023/135231, filed on Nov. 29, 2023, which claims priority to China Application Serial Number 202311333618.5, filed on Oct. 16, 2023. The entire disclosures of all the above applications are hereby incorporated by reference.

### FIELD OF THE INVENTION

The present invention relates to an optical device, particularly referring to an optical film, backlight module, and display device that possess a specific light emission angle.

### BACKGROUND OF THE INVENTION

With the upgrading of vehicle configurations, existing in-vehicle displays, such as those located on the center console, require a significantly wide viewing angle in the horizontal direction. Additionally, certain vehicle models may also include screens for the passenger or other occupants to view. For safety reasons, displays not intended for the driver's viewing must incorporate anti-peep functionality to avoid distracting the driver. In specific situations, such as with digital virtual exterior mirrors, the image from the exterior mirrors on the vehicle doors is captured and projected onto screens mounted on the sides of the doors. In this case, the viewing angle is quite concentrated on one side. However, the existing backlight module architecture fails to meet the diverse and specialized viewing angle requirements of automotive displays.

### SUMMARY OF THE INVENTION

One object of the present invention is to provide an optical film capable of producing light at a specific emission angle.

The optical film comprises a substrate and a plurality of microstructures arranged on the substrate. The substrate has a light incident surface and a light emitting surface opposite to the light incident surface, wherein the substrate is defined to have a first direction and a second direction perpendicular to the first direction. The microstructures are arranged on the light incident surface of the substrate, wherein the cross-sectional shape of the microstructures in the first direction differs from the cross-sectional shape in the second direction. Each microstructure has multiple optical surfaces and a boundary line connecting the multiple optical surfaces, said boundary line being a straight line and parallel to the light incident surface of the substrate.

In a preferable embodiment, a first projection plane is defined to be perpendicular to the first direction, and a second projection plane is defined to be perpendicular to the second direction. Each microstructure has two first optical surfaces arranged along the second direction and facing each other, and a second optical surface and a third optical surface arranged along the first direction and facing each other. The shape of the projection of each first optical surface onto the second projection plane is an asymmetric triangle, with two sides connected to the second optical surface and the third optical surface. The shapes of the projections of the second optical surface and the third optical surface onto the first projection plane are trapezoidal, with the slope of the second optical surface being greater than that of the third optical surface, and the boundary line of each microstructure is the connecting edge between the second optical surface and the third optical surface.

In a preferable embodiment, an air gap is present between the first optical surface of any of the microstructures and the first optical surface of an adjacent microstructure, and an air gap is also present between the second optical surface of any of the microstructures and the third optical surface of an adjacent microstructure.

In a preferable embodiment, shape of the projection of each first optical surface of each microstructure onto the second projection surface is a right triangle, with one of the base angles being a right angle.

In a preferable embodiment, the second optical surface and the third optical surface of each microstructure has two side edges that are not parallel to the boundary line, and the side edges are connected to the light incident surface of the substrate.

In a preferable embodiment, the second optical surface of each microstructure is perpendicular to the light incident surface of the substrate, and the area of the projection of each second optical surface onto the first projection plane is equal to the area of the second optical surface itself.

In a preferable embodiment, the third optical surface of each microstructure is inclined relative to the light incident surface of the substrate, and the area of the projection of each third optical surface onto the first projection plane is less than the area of the third optical surface itself.

In a preferable embodiment, the optical film further comprises a plurality of prism structures disposed on the output surface of the substrate, wherein the prism structures extend along the second direction.

In a preferable embodiment, the cross-sectional shape of each prism structure in the second direction is an isosceles triangle with a right-angle vertex.

In a preferable embodiment, the cross-sectional shape of each prism structure in the second direction is a non-isosceles triangle.

In a preferable embodiment, the cross-sectional shape of each prism structure in the first direction comprises a first working surface and a second working surface connected together, with a first angle between the first working surface and the light emitting surface and a second angle between the second working surface and the light emitting surface, wherein the first angle is smaller than the second angle, the shape of the projection of each first optical surface of each input microstructure onto the second projection surface is a right triangle, with one of the base angles being a right angle, and the first angle and the right angle are on the same side.

In a preferable embodiment, each prism structure is a strip structure that is either recessed or protruded from the light emitting surface.

Another object of the present invention is to provide a backlight module which comprises the optical film as described above, and a light source that projects light onto the light incident surface of the optical film.

Another object of the present invention is to provide a display device which comprises the backlight module as described above, and a display panel arranged on the backlight module.

The characteristic of the present invention lies in utilizing the boundary line of each microstructure, which connects multiple optical surfaces while being parallel to the light incident surface of the substrate. This configuration allows a portion of the light to enter through the light incident surface and pass directly through the boundary line without being split, while another portion is split to the sides. This arrangement enables the light to expand the viewing angle along the same axis. Furthermore, by having the cross-sectional shape of the microstructure differ in the first direction compared to the second direction, light can expand the viewing angle along a specific axis while simultaneously being deflected towards one side, achieving the purpose of directing light at a specific angle.

### BRIEF DESCRIPTION OF THE DRAWINGS

FIG. 1 is a perspective view, which is a preferred embodiment of the optical film of the present invention, wherein the optical film includes a plurality of microstructures.

FIG. 2 is a perspective view, which is another perspective of FIG. 1 that is flipped 180 degrees vertically to assist in explaining FIG. 1.

FIG. 3 is a top view illustrating FIG. 2 from another angle.

FIG. 4 is a side view illustrating the shape of a first optical surface of the microstructure on a second projection plane of the optical film.

FIG. 5 is a side view illustrating the shape of a second optical surface of the microstructure on a first projection plane of the optical film.

FIG. 6 is a side view illustrating the shape of a third optical surface of the microstructure on the first projection plane of the optical film.

FIG. 7 is a side view of a preferred embodiment of a backlight module of the present invention.

FIG. 8 is a simulated energy distribution diagram, illustrating the deflection of energy and viewing angle of light after passing through the optical film shown in FIG. 2.

FIG. 9 is a schematic diagram illustrating the viewing angle specifications for an automotive digital rearview mirror.

FIG. 10 is a side view illustrating an alternative form of the plurality of prism structures in the optical film of the preferred embodiment.

FIG. 11 is a schematic diagram illustrating an enlargement of the area highlighted in FIG. 9.

FIG. 12 is a simulated energy distribution diagram, illustrating the deflection of energy and viewing angle of light after passing through the optical film shown in FIG. 10.

FIG. 13 is a side view of a preferred embodiment of a display device of the present invention.

### DETAILED DESCRIPTION OF THE INVENTION

The detailed description and preferred embodiments of the invention will be set forth in the following content and provided for people skilled in the art to understand the characteristics of the invention.

The words “approximately”, “approximately”, “approximately” or “substantially” appearing in the content of this case not only cover the clearly stated numerical values and numerical ranges, but also covers the allowable deviation range that can be understood by a person with ordinary knowledge in the technical field to which the invention belongs. The deviation range can be determined by the error generated during measurement, and this error is caused, for example, by limitations of the measurement system or process conditions. In addition, “about” may mean within one or more standard deviations of the above numerical value, such as within ±5%, ±3%, or ±1%. Words such as “about”, “approximately”, “approximately” or “substantially” appearing in this text may be used to select acceptable deviation ranges or standard deviations based on optical properties, etching properties, mechanical properties, or other properties. Therefore, a single standard deviation is not applied to all the above optical properties, etching properties, mechanical properties, and other properties.

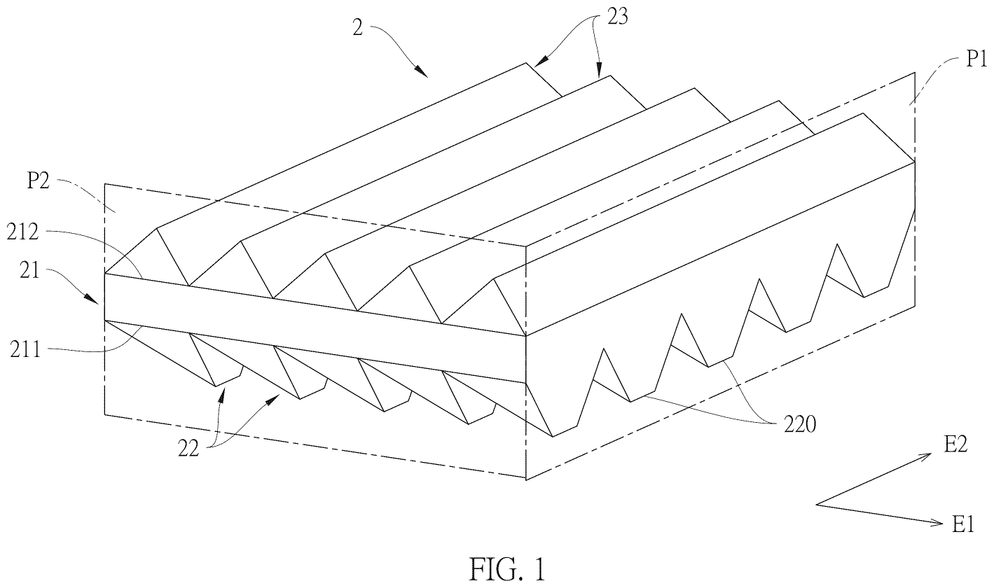

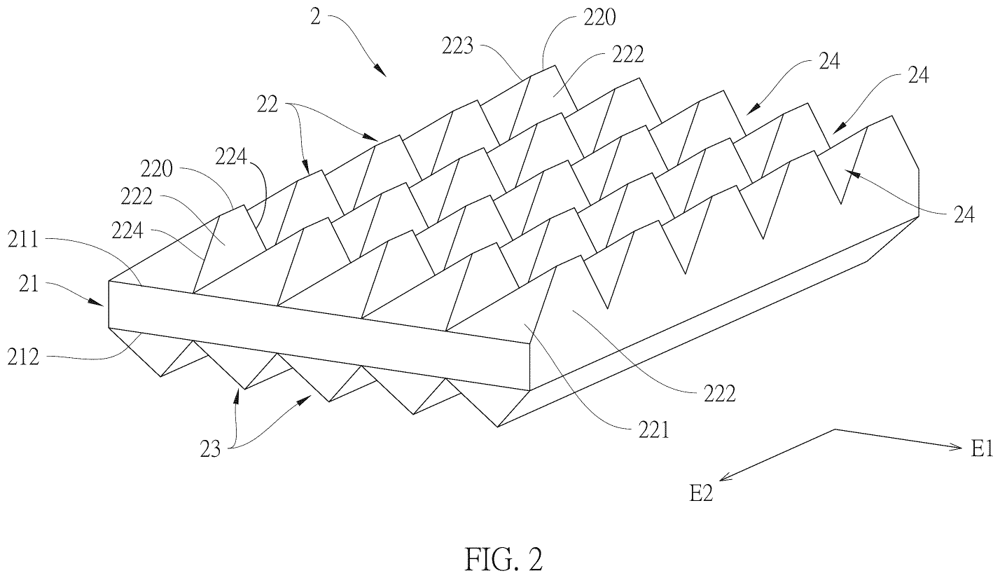

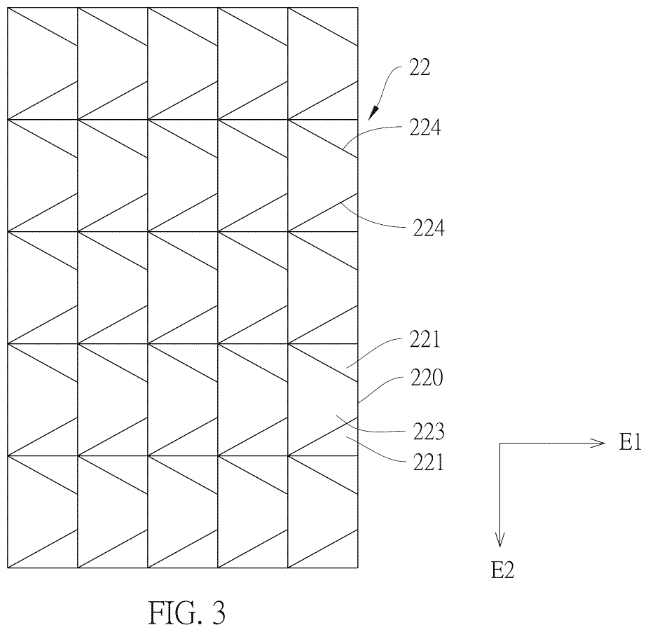

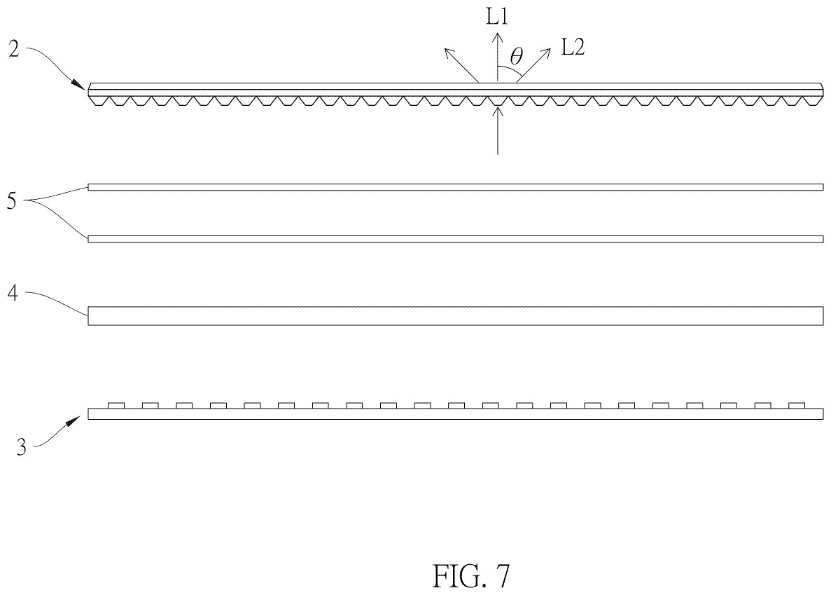

Referring to FIG. 1 and FIG. 2, it is a preferred embodiment of an optical film of the present invention. The optical film 2 comprises a substrate 21, along with a plurality of microstructures 22 and a plurality of prism structures 23 arranged on the substrate 21. It is noteworthy that FIG. 2 presents the angle of FIG. 1 inverted, while FIG. 3 serves as a top view of FIG. 2, providing a clearer depiction of the detailed structure of the microstructures 22. The substrate 21 comprises a light incident surface 211 and a light emitting surface 212 opposite to the light incident surface 211. The microstructures 22 are arranged on the light incident surface 211, while the prism structures 23 are positioned on the light emitting surface 212. The substrate 21 is defined to have a first direction E1 and a second direction E2 that is perpendicular to the first direction E1. The cross-sectional shape of the microstructures 22 differs in the first direction E1 compared to the second direction E2. Each microstructure 22 has multiple optical surfaces and a boundary line 220 connecting these optical surfaces. The boundary line 220 is a straight line that is parallel to the light incident surface 211 of the substrate 21. The boundary line 220 of the microstructure 22 connects multiple optical surfaces while being parallel to the light incident surface 211 of the substrate 21. This arrangement allows a portion of light (as shown in L1 of FIG. 7) to pass directly through the boundary line 220 without being split, while another portion of light (as shown in L2 of FIG. 7) is dispersed to both sides. Consequently, the light can expand the field of view along the same axis. Furthermore, the cross-sectional shape of the microstructure 22 in the first direction E1 differs from that in the second direction E2, enabling the light to not only expand the field of view along a certain axis but also be deflected towards one side to achieve specific output angles.

Referring to FIG. 2 and FIG. 3, each of the microstructures 22 comprises two first optical surfaces 221 that are arranged along the second direction E2 and facing each other, and a second optical surface 222 and a third optical surface 223 that are along the first direction E1 and facing each other. As shown in FIG. 3, the two sides of each first optical surface 221 are respectively connected to the second optical surface 222 and the third optical surface 223.

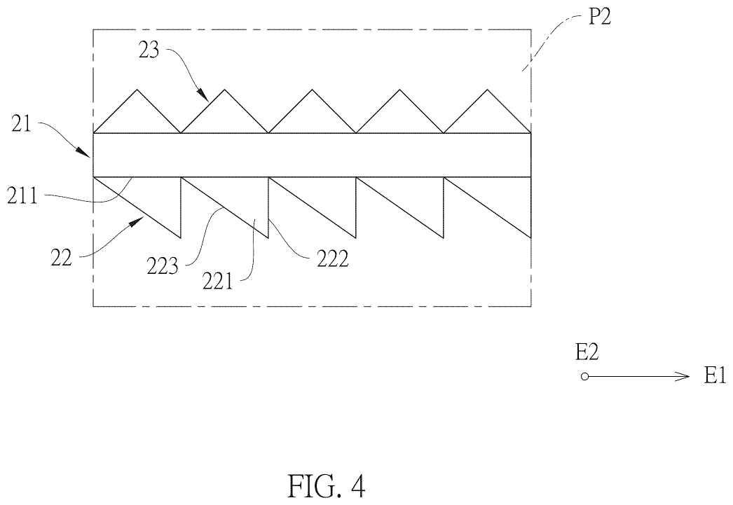

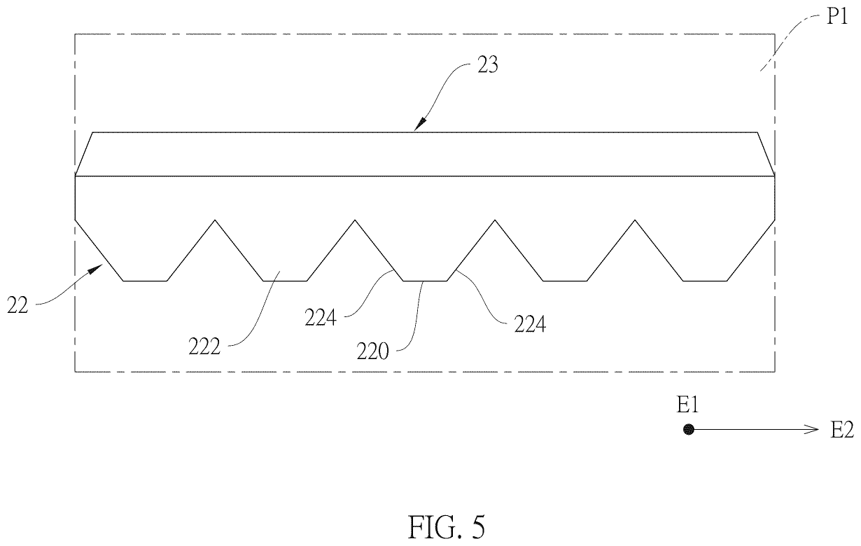

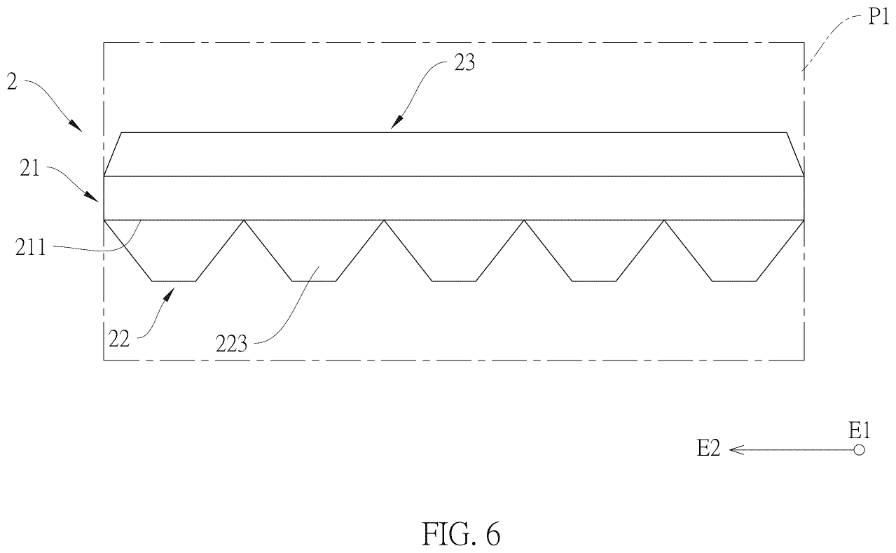

Referring to FIG. 1, a first projection plane P1 is defined as being perpendicular to the first direction E1, and a second projection plane P2 is defined as being perpendicular to the second direction E2. Referring to FIG. 1 and FIG. 4, the shape of the projection of each first optical surface 221 of each microstructure 22 onto the second projection plane P2 is an asymmetric triangle. Referring to FIG. 1 and FIG. 5, the shape of the projection of the second optical surface 222 onto the first projection plane P1 is trapezoidal. Referring to FIG. 1 and FIG. 6, the shape of the projection of the third optical surface 223 onto the first projection plane P1 is also trapezoidal, and as shown in FIG. 4, the slope of the second optical surface 222 is greater than the slope of the third optical surface 223. Due to the trapezoidal design, as shown in the second optical surface 222 in FIG. 2 and the third optical surface 223 in FIG. 3, not only does it generate a trapezoidal top edge (boundary line 220) that is parallel to the light incident surface 211 of the substrate 21, but it also produces trapezoidal side edges 224 that are inclined with respect to the light incident surface 211 of the substrate 21. This configuration allows a portion of the light to pass more directly through the trapezoidal top edge without being split, while another portion of the light is dispersed by the side edges 224 of the trapezoid to both sides more directly. Therefore, the design allows light to achieve a splitting effect along the same axis (for example, the second direction E2), thereby expanding the field of view. In contrast, along another axis (for example, the first direction E1), the cross-sectional shape of the microstructure 22 along the first direction E1 (such as the asymmetric triangle of the first optical surface 221 shown in FIG. 2) differs from the cross-sectional shape along the second direction E2 (such as the trapezoidal shape of the second optical surface 222 shown in FIG. 2). This results in no splitting effect for light along the first direction E1; instead, the design of the asymmetric triangle produces a light-deflecting effect. Consequently, light can expand the field of view along one axis while being deflected toward one side.

Further, each of the first optical surfaces 221 of the microstructures 22 projects onto the second projection plane P2 in the shape of a right triangle, wherein one of the base angles is a right angle, as shown in FIG. 4.

Through the design of the above-mentioned right-angled triangle, the light can hardly produce a deflection effect on the right-angled surface and can produce a light deflection effect on the bevel surface at a maximum ratio. In this way, the light can be deflected towards one side to the maximum proportion in the axis direction that does not produce the light splitting effect (that is, the first direction E1).

Referring to FIG. 1 and FIG. 4, the second optical surface 222 of each microstructure 22 is perpendicular to the light incident surface 211 of the substrate 21, while the first projection plane P1 is perpendicular to the first direction E1 and also perpendicular to the light incident surface 211 of the substrate 21. Therefore, the area of the projection of the second optical surface 222 onto the first projection plane P1 is equal to the area of the second optical surface 222 itself. Additionally, the third optical surface 223 of each light-incident microstructure 22 is inclined with respect to the light incident surface 211 of the substrate 21. The area of the projection of the third optical surface 223 onto the first projection plane P1 is less than the area of the third optical surface 223 itself.

Referring to FIG. 2 and FIG. 3, the boundary line 220 of each microstructure 22 refers to the connecting edge between the second optical surface 222 and the third optical surface 223. Additionally, the second optical surface 222 and the third optical surface 223 of each microstructure 22 have two side edges 224, wherein the side edges 224 are not parallel to the boundary line 220 and connect to the light incident surface 211 of the substrate 21.

Referring to FIG. 2, there is an air gap 24 between the first optical surface 221 of any microstructure 22 and the first optical surface 221 of an adjacent microstructure 22. Additionally, there is also an air gap 24 between the second optical surface 222 of any microstructure 22 and the third optical surface 223 of an adjacent microstructure 22. This design ensures that the microstructures 22 are separated and not connected, whether in the first direction E1 or the second direction E2. This separation helps to produce splitting or deflection effects without interference from other strip-like structures affecting the optical performance.

Referring to FIG. 1 and FIG. 4, in this embodiment, the cross-sectional shape of each prism structure 23 in the second direction E2 (equivalent to the shape projected onto the second projection plane P2) is an isosceles triangle with a right angle at the vertex. This design enhances the brightness enhancement effect as light exits the light emitting surface 212.

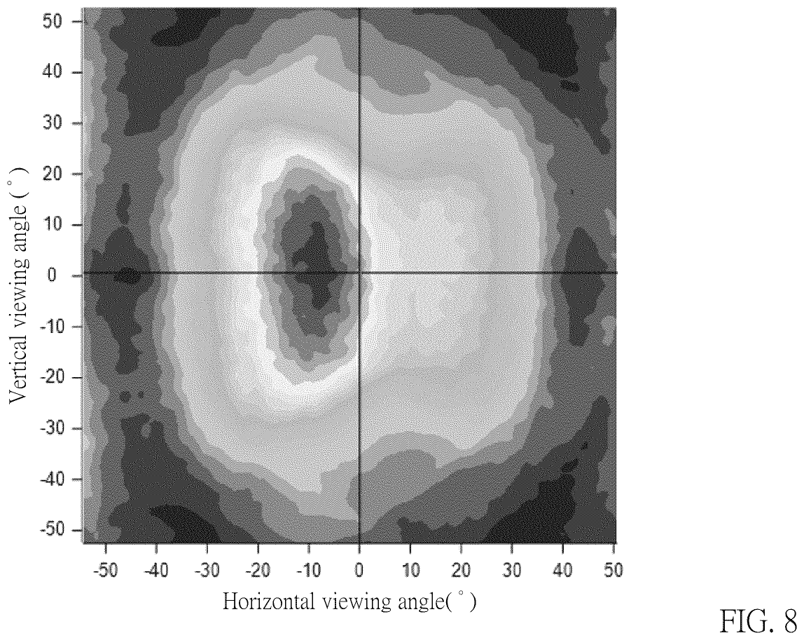

Referring to FIG. 7, the backlight module of the present invention includes a light source 3, a diffusion plate 4 positioned on the light emitting side of the light source 3, a plurality of films 5, and the aforementioned optical film 2. The light from the light source 3 first passes through the diffusion plate 4 to form a more uniform surface light source before subsequently passing through the optical film 2. Referring to FIG. 5, after the light interacts with the optical film 2, a portion of the light (for example, light L1) will pass through the boundary line 220 of the microstructure 22 and exit in the front view direction, while another portion of the light (for example, light L2) can exit in the side view direction due to the action of the microstructure 22. Wherein, the front view direction refers to the direction of light parallel to the normal of the optical film 2, while the side view direction forms an angle θ with the front view direction. This configuration allows a portion of the direct light to be converted to other angular directions, thereby expanding the field of view in a specific direction (for example, the vertical direction). Additionally, referring to FIG. 4, in the first direction E1, each microstructure 22 has an asymmetric form, where the second optical surface 222 is a vertical trapezoidal surface and the third optical surface 223 is an inclined trapezoidal surface. As a result, when a portion of the light passes through the light-incident microstructure 22, it is effectively directed by the third optical surface 223 towards a specific lateral exit direction. At the same time, since the second optical surface 222 is perpendicular to the light incident surface 211 and the light source 3 below, it almost does not refract the light, effectively suppressing the light-emission efficiency of the second optical surface 222. This allows for maximum deflection effects on the third optical surface 223, enabling the light to concentrate towards one side along the axis (i.e., the first direction E1) where no splitting effect occurs with maximum efficiency and advantage. Through the aforementioned design, as illustrated in the simulated energy distribution diagram in FIG. 8, the optical film 2 of this preferred embodiment can generate strong energy in the darker regions between ±20 degrees in the vertical direction, while also producing the strongest light energy in the darker region near −10 degrees in the horizontal direction. This not only allows for the adjustment of the viewing field in the vertical direction but also further guides and deflects the light to specific angles.

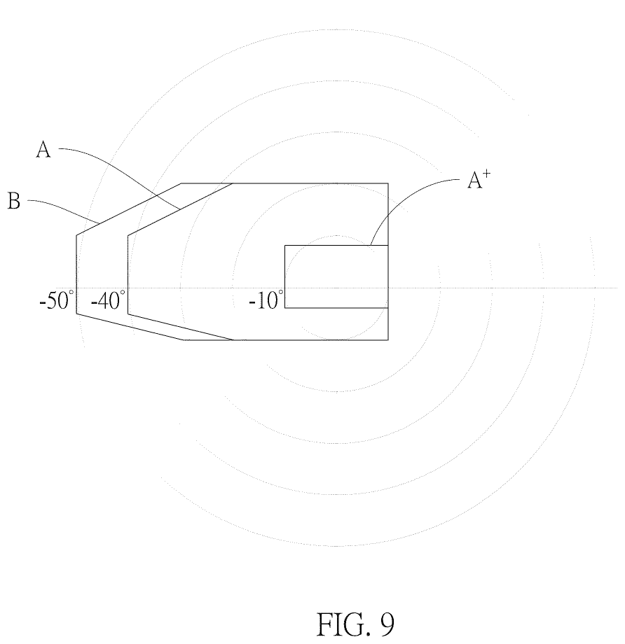

Referring to FIG. 9, which illustrates a schematic of the viewing angle specifications for a vehicle digital rearview mirror, the digital rearview mirror can be divided into areas A+, A, and B based on different viewing positions, each having specific light output requirements. Therefore, when the preferred embodiment of the optical film of the present invention is applied to a vehicle digital rearview mirror, the simulated energy distribution diagram in FIG. 8 can meet the viewing angle specifications for areas A+ and A. Specifically, it generates the strongest light energy in the darker region near −10 degrees in area A+, while the lighter region extends to approximately −40 degrees in area A, complying with the light output requirements.

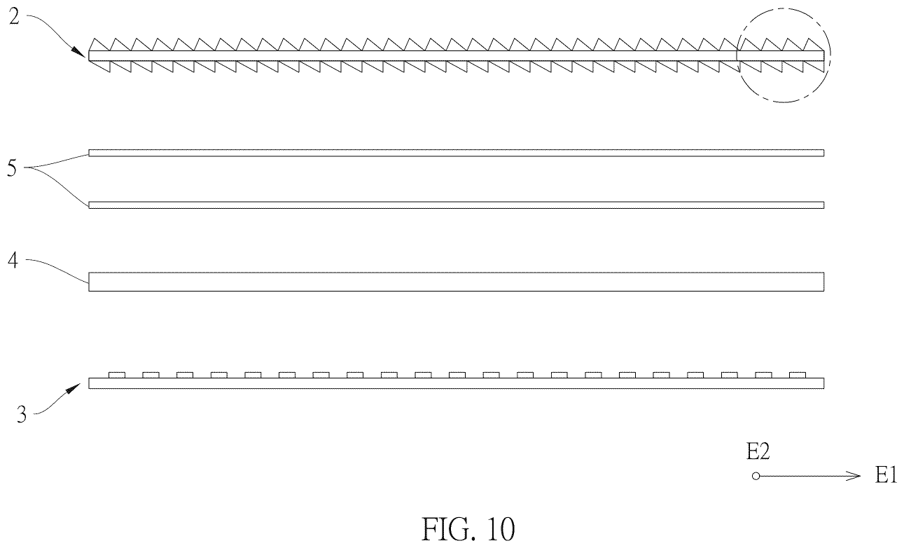

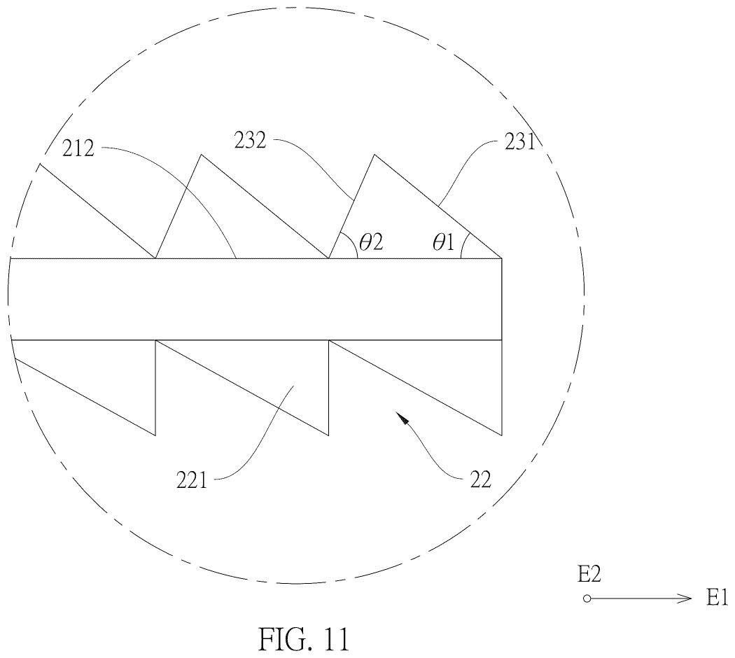

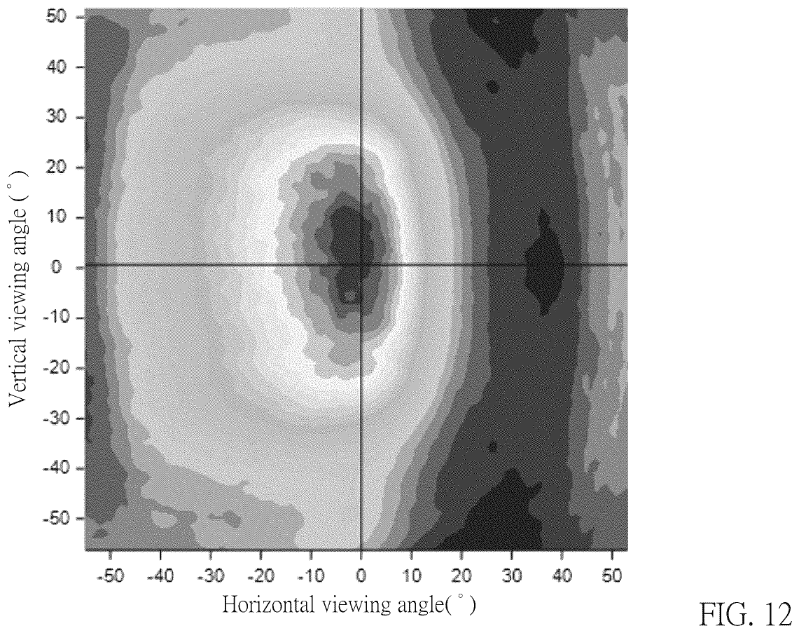

Referring to FIG. 10 and FIG. 11, in some embodiments, the cross-sectional shape of each prism structure 23 in the second direction E2 is a non-isosceles triangle. Each prism structure 23 has a first working surface 231 and a second working surface 232 that are connected in the first direction E1. The first working surface 231 has a first angle θ1 with respect to the light emitting surface 212, while the second working surface 232 has a second angle θ2 with respect to the light emitting surface 212, where the first angle θ1 is smaller than the second angle θ2. As previously mentioned, in the perspective shown in FIG. 11, one of the base angles of each first optical surface 221 of the microstructures 22 is a right angle, and the first angle θ1 is located on the same side as the right angle. In other words, along the first direction E1, the tips of each prism structure 23 and the tips of each microstructure 22 are oriented in different directions. This design allows for the adjustment of the deflection direction and light-emission range after the light passes through the optical film 2. As seen in the simulated energy distribution in FIG. 12, the design adjusts to produce the strongest light energy in the darker region near 0 degrees in area A+, while reducing the deflection effect of light towards the negative horizontal direction on the left side of area A+. At the same time, energy in the horizontal direction greater than 20 degrees on the right side is shifted to the negative horizontal direction on the left side, resulting in the lighter region extending further into area B, approaching −50 degrees. This configuration is more aligned with the viewing angle specifications for areas A+, A, and B in vehicle digital rearview mirrors.

Additionally, it should be noted that in this embodiment, each prism structure 23 is a strip-like structure that protrudes from the light emitting surface 212. In certain embodiments, each prism structure 23 may also be a strip-like structure that is recessed into the light emitting surface 212.

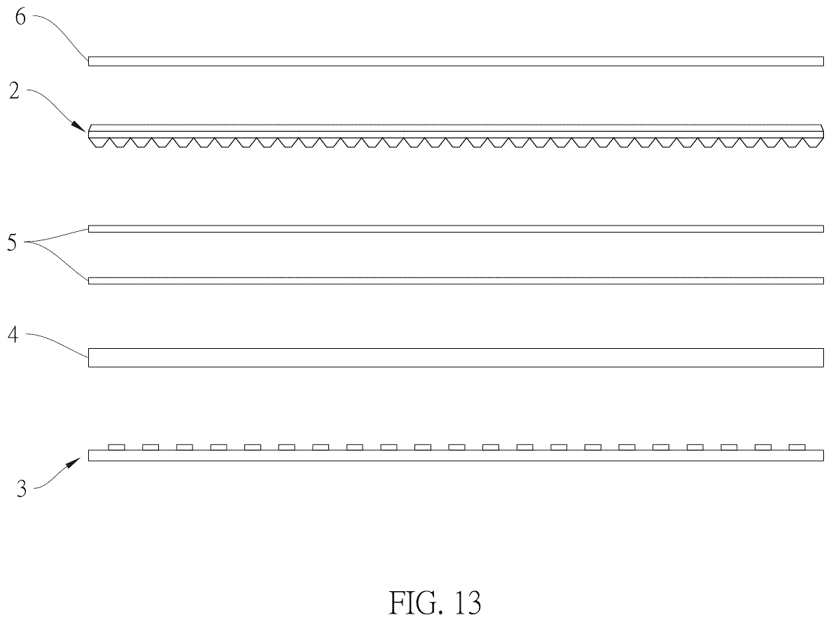

Referring to FIG. 13, a display panel 6 is positioned on the backlight module, constituting the display device of the present invention.

In summary, the present invention primarily enhances the overall field of view by utilizing the design of the light incident microstructures 22 on the optical film 2 to convert a portion of direct light into other angular directions. Additionally, it allows for the deflection of light towards specific angles to meet the viewing angle requirements of different vehicle-mounted display devices.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An optical film, comprising:
a substrate having a light incident surface and a light emitting surface opposite to the light incident surface, wherein the substrate is defined to have a first direction and a second direction perpendicular to the first direction; and
a plurality of microstructures arranged on the light incident surface of the substrate, wherein the cross-sectional shape of the microstructures in the first direction differs from the cross-sectional shape in the second direction, and wherein each microstructure has multiple optical surfaces and a boundary line connecting the multiple optical surfaces, said boundary line being a straight line and parallel to the light incident surface of the substrate.

2. The optical film as claimed in claim 1, wherein a first projection plane is defined to be perpendicular to the first direction, a second projection plane is defined to be perpendicular to the second direction, each microstructure has two first optical surfaces arranged along the second direction and facing each other, and a second optical surface and a third optical surface are arranged along the first direction and facing each other, wherein the shape of the projection of each first optical surface onto the second projection plane is an asymmetric triangle, with two sides connected to the second optical surface and the third optical surface, the shapes of the projections of the second optical surface and the third optical surface onto the first projection plane are trapezoidal, with the slope of the second optical surface being greater than that of the third optical surface, and the boundary line of each microstructure is the connecting edge between the second optical surface and the third optical surface.

3. The optical film as claimed in claim 2, wherein an air gap is present between the first optical surface of any of the microstructures and the first optical surface of an adjacent microstructure, and an air gap is also present between the second optical surface of any of the microstructures and the third optical surface of an adjacent microstructure.

4. The optical film as claimed in claim 2, wherein the shape of the projection of each first optical surface of each microstructure onto the second projection surface is a right triangle, with one of the base angles being a right angle.

5. The optical film as claimed in claim 2, wherein the second optical surface and the third optical surface of each microstructure has two side edges that are not parallel to the boundary line, and the side edges are connected to the light incident surface of the substrate.

6. The optical film as claimed in claim 2, wherein the second optical surface of each microstructure is perpendicular to the light incident surface of the substrate, and the area of the projection of each second optical surface onto the first projection plane is equal to the area of the second optical surface itself.

7. The optical film as claimed in claim 6, wherein the third optical surface of each microstructure is inclined relative to the light incident surface of the substrate, and the area of the projection of each third optical surface onto the first projection plane is less than the area of the third optical surface itself.

8. The optical film as claimed in claim 1, further comprising a plurality of prism structures disposed on the output surface of the substrate, wherein the prism structures extend along the second direction.

9. The optical film as claimed in claim 8, wherein the cross-sectional shape of each prism structure in the second direction is an isosceles triangle with a right-angle vertex.

10. The optical film as claimed in claim 8, wherein the cross-sectional shape of each prism structure in the second direction is a non-isosceles triangle.

11. The optical film as claimed in claim 10, wherein the cross-sectional shape of each prism structure in the first direction comprises a first working surface and a second working surface connected together, with a first angle between the first working surface and the light emitting surface and a second angle between the second working surface and the light emitting surface, wherein the first angle is smaller than the second angle, the shape of the projection of each first optical surface of each input microstructure onto the second projection surface is a right triangle, with one of the base angles being a right angle, and the first angle and the right angle are on the same side.

12. The optical film as claimed in claim 8, wherein each prism structure is a strip structure that is either recessed or protruded from the light emitting surface.

13. A backlight module, comprising the optical film as described in claim 1, and a light source that projects light onto the light incident surface of the optical film.

14. A display device, comprising the backlight module as described in claim 13, and a display panel arranged on the backlight module.
